(19) United States
(12) Patent Application Publication
(10) Pub. No.: US 2018/0261022 A1
(43) Pub. Date: Sep. 13, 2018

(54) SYSTEM AND METHOD FOR PRESERVING HELICOPTER DATA

(71) Applicant: Eric Robert Bechhoefer, Cornwall, VT (US)

(72) Inventor: Eric Robert Bechhoefer, Cornwall, VT (US)

(73) Assignee: Green Power Monitoring Systems, Inc., Cornwall, VT (US)

(21) Appl. No.: 15/918,036

(22) Filed: Mar. 12, 2018

Related U.S. Application Data
(60) Provisional application No. 62/470,518, filed on Mar. 13, 2017.

(51) Int. Cl. G07C 5/08; B64D 43/00

(52) U.S. Cl. CPC G07C 5/085; B64C 27/04; B64D 43/00

(57) ABSTRACT

A system is provided for aircraft that automates the download of flight data in the event of a hard landing or mishap that can increase the likelihood that the flight data is preserved so the flight data could be used to facilitate the reconstruction of events leading up to the flight mishap. An aircraft regime recognition technique is provided in which measured parameters are used to determine a likely regime based on a noise tolerant algorithm that is both scalable and has a low computational complexity.

### RELATED APPLICATION DATA

This application claims the benefit of U.S. Provisional Application No. 62/470,518 filed on Mar. 13, 2017 and titled System and Method for Preserving Helicopter Data, which is incorporated herein in its entirety.

### FIELD OF THE INVENTION

The present invention generally relates to helicopter monitoring systems. In particular, the present invention is directed to a system and method for determining helicopter regimes and preserving the integrity of flight or operation data.

### BACKGROUND

Health and Usage Monitoring Systems (HUMS) can be used in helicopters to determine and collect information during helicopter operations. HUMS can obtain data associated with the health of rotating equipment as well as parameter data associated with helicopter flight data monitoring (HFDM), which can be used to reconstruct a helicopter flight operation.

Currently there are two general methods for the reporting of flight data obtained via HUMS—using wireless communications systems or using a crash survivable flight data recorder.

Wireless communication systems, such as the Aircraft Communications Addressing and Reporting System, can be used to transmit data in real time. In the event of a mishap, these systems allow a subset of the flight data to be retained to help investigators reconstruct events that occurred just before the mishap. These types of data transfer systems are relatively expensive because the depend on satellite communications. Further, because they use relatively low bandwidth, it may not be possible to transfer all the data that may be pertinent to the mishap.

Crash survivable data recorders must be constructed to withstand impact and survive at high temperatures for a protracted period of time. As such, the use of crash survivable data recorders adds both cost and weight to a HUMS. In addition, such data recorders are not always recoverable or do not survive intact.

In general, flight data recorders and HUMS are not required on most helicopters. While there is a proven track record that the inclusion of HUMS on aircraft reduces operational costs and improves aircraft readiness and safety, HUMS are not included on the vast majority of Part 27 aircraft. (Part 27 aircraft are defined as helicopters with a maximum weight of up to 7000 pounds and nine or fewer passenger seats.) For these types of aircraft, cost and weight can be important factors in whether to include a HUMS.

Flight data can be preserved in the event of a mishap without adding significant cost or weight to a HUMS if the flight data can be downloaded when a mishap occurs or is likely to occur. Such a determination depends in part on being able to accurately recognize the regime an aircraft is in. Regime recognition entails determining the state of an aircraft, such as whether the aircraft is idling, ascending, descending, turning, etc., based on observed flight data and other parameters. Regime recognition is important for a number of HUMS related functions, including: determining when a mechanical diagnostics acquisition can be taken: calculating flight statistics (e.g., flight time and rotor turn time); determining that the end of all operation has occurred for downloading of flight data; and determining whether the aircraft has experienced a hard landing or other mishap. In addition, the accurate determination of flight regimes facilitates flight reconstruction and can provide useful information related to aircraft safety and maintenance.

To those ends, regime recognition can assist in identifying when the rotor is turning, identifying when the aircraft is flying (for the calculation of total flight time for the operation), determining when the aircraft is not fling or in ground operation (so that RF communications such as Wi-Fi or a cellular modem can be used to download data), determining whether the aircraft has suffered a hard landing (for reporting and investigating as well as for triggering the download of flight data), and determining when acquisitions for rotor track and balance and mechanical diagnostics can be performed.

Additionally, regime recognition allows for an estimate of actual usage of a component that is better than a usage estimate based on flight hours or ground-air-ground cycles.

Prior art recognition regimes have been based on algorithms that use logical tests or neural networks. These logical tests, however, can be prone to errors due to inherently noisy parameters. And neural networks in general are difficult to certify and can require a large amount of training data before reliable results are obtainable.

Therefore, there is a need for a way to automate the download of flight data that can increase the likelihood that the flight data is preserved in the event of a mishap that can be implemented without adding significant cost or, weight to a HUMS, thereby allowing the flight data to facilitate the reconstruction of events leading up to the flight mishap. This automated downloading of flight data can be based in part on art improved recognition regime protocol that is based on a noise tolerant algorithm and that is both scalable and has a low computational complexity.

### SUMMARY OF THE DISCLOSURE

A system for preserving flight data is provided that includes a plurality of instruments on an aircraft for measuring a set of aircraft operation parameters during operation of the aircraft, wherein each of the parameters has a value. A regime monitor on the aircraft and in communication with the plurality of instruments receives the set of aircraft operation parameters and determines a normalized distance between the values of the set of aircraft operation parameters and a set of corresponding parameter values for each of n such sets of corresponding parameter values, each set being associated with one of n notional regime states. A probability, for each of the n regime states, that the aircraft is in a one of the n regime states is determined and the regime monitor then selects the one of the n regime states with the highest probability as a current regime state the aircraft is most likely in. A HUMS unit is also included on the aircraft that includes a persistent memory, an active directory, a transfer directory, and an archive directory, wherein the persistent memory contains a file with aircraft operation data recorded during operation of the aircraft. When the current regime state indicates that the aircraft likely has had or might soon have a mishap, the aircraft operation data is sent to the transfer directory and downloaded from the aircraft.

In another embodiment, a method for preserving flight data is provided that includes recording flight data on an aircraft and measuring a plurality of values for a set of aircraft operation parameters for the aircraft. The plurality of aircraft operation parameters are input into a maximum likelihood estimator, wherein the maximum likelihood estimator determines a normalized distance between the values of the set of aircraft operation parameters and a set of corresponding parameter values for each of n such sets of corresponding parameter values, each set being associated with one of n notional regime states. The maximum likelihood estimator then determines, for each of the n regime states, a probability that the aircraft is in a one of the n regime states based on the determined normalized distance for each of the n regime states. A current regime state the aircraft is most likely in based on the determined probabilities is selected, and, if the selected regime state is associated with an increased likelihood that a flight mishap has occurred or an increased likelihood of an imminent flight mishap, the flight data is transferred off to aircraft via an available communications network.

In another embodiment, a system of preserving flight data is provided that includes a HUMS unit on an aircraft, the HUMS unit including a persistent memory, an active directory, a transfer directory, and an archive directory, wherein the persistent memory contains a file with aircraft operation data for the aircraft. The system also includes a cellular modem, a satellite modem, and a power storage device that is designed and configured to power the HUMS unit, the cellular modem and the satellite modem if no other sources of power are available on the aircraft. A regime recognizer is also included for determining a regime state the aircraft is in. When the regime state indicates that the aircraft likely has had a mishap or might soon have a mishap, the aircraft operation data is sent to the transfer directory and downloaded from the aircraft via Wi-Fi unless Wi-Fi is unavailable, via the cellular modem if the Wi-Fi is unavailable unless cellular connectivity is unavailable, and via the satellite modem if Wi-Fi and cellular connectivity are both unavailable.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic of exemplary components of an aircraft operation data detection and recordation system of the present invention on an aircraft;

FIG. 2 is a schematic of exemplary health and usage monitoring system component of the present invention;

FIG. 3 is a block diagram of an exemplary method of the present invention for preserving flight data in the event of a mishap; and

FIG. 4 is a block diagram of an exemplary method of the present invention for recognizing a regime of an aircraft based on flight operations parameters.

### DESCRIPTION OF THE DISCLOSURE

A regime recognition technique according to the present disclosure provides improved accuracy in determining what state an aircraft is in based on a noise tolerant algorithm that is both scalable and has a low computational complexity. A more accurate regime recognition technique allows for improved estimates of component usage and determination of whether an aircraft has experienced or may experience a mishap or hard landing, which can allow for flight data to be preserved by having it transmitted or downloaded in the event of a mishap or increased possibility of a mishap. In this way, the likelihood of flight data surviving a mishap can be increased without adding significant cost or weight to a HUMS. Furthermore, more accurate regime recognition enables better flight reconstruction and allows for the gathering of more accurate information that pertains to decisions regarding aircraft safety and maintenance.

Aircraft operation data, or flight data, is information about an aircraft and an operation or flight of the aircraft that is, among other things, needed to reconstruct a flight. Aircraft operation data is monitored, collected and recorded from when an aircraft first starts until it shuts down and may include, for example, rotor turn time, flight time, flight parameters, regime data (i.e., data concerning the state the aircraft is in, e.g., descending left turn), exceedances, mechanical diagnostics, rotor and track balances acquisition data, ending of operation, and priority of data download.

Files are created at the beginning of any aircraft operation to store aircraft operation data for that particular operation. Aircraft operation data, once recorded, consists of files identified by the specific aircraft involved in the operation as well as the date and time of the operation. These files contain the data generated during the flight or operation. For example, an operation may be a rotor turn that does not result in a flight; which is known as a ground operation, or a several hour out and back flight. The data includes, for example, information related to exceedances (operational limits defined by the original equipment manufacturer), flight parameters (such as latitude, longitude, altitude, velocities, accelerations, engine performance, and airspeed), mechanical diagnostics, the condition of rotating equipment, the condition of the transmission, and error logs.

All the aircraft operation data must be associated with a particular flight or operation, so from power on, to rotor turn, through the flight, to landing, all recorded flight operation data is kept in a file created for that flight or operation. (It should be noted that aircraft operations are only associated with a flight or a rotor turn. For example, if power is applied to the aircraft and then removed without the aircraft being started, files that were created in anticipation of an operation are normally deleted.)

Aircraft operation data associated with an aircraft operation is typically downloaded at the end of every operation. Depending on whether the end of an operation is normal or results in a mishap, there may be different priorities regarding which files to download and how those files are downloaded. For example, for a normal flight, there is a period of time associated with aircraft shutdown during which the aircraft operation data can easily be downloaded, such as via Wi-Fi, to a tablet computer, smart phone, or other portable device the pilot may have, or to a computer at a nearby Wi-Fi equipped base station. Wi-Fi is the typical download method since there is no cost associated with the bandwidth required for downloading files containing aircraft operation data. Wi-Fi can also establish a virtual private network (VPN) to ensure the security of the data. Alternatively, if no Wi-Fi is available and the aircraft state is normal (i.e., there was no hard landing or mishap), the files can be held in persistent memory on the aircraft, such as in a HUMS, until Wi-Fi is available. However, if an operation terminates due to a hard landing or mishap, it is important that the aircraft operation data is downloaded by whatever means are currently available, such as local cellular modem using LTE (100 Mb/s download), UMTS/HSPA (3G 7.2 Mb/s) or GSM/GPSR (2.5G 85.6 kb/s). Downloading priorities are thus determined in part by whether an aircraft has experienced a mishap or hard landing, which can be determined, or the likelihood of such anticipated, in part by accurate determination of the regime an aircraft is in and/or the regimes the aircraft has been in recently.

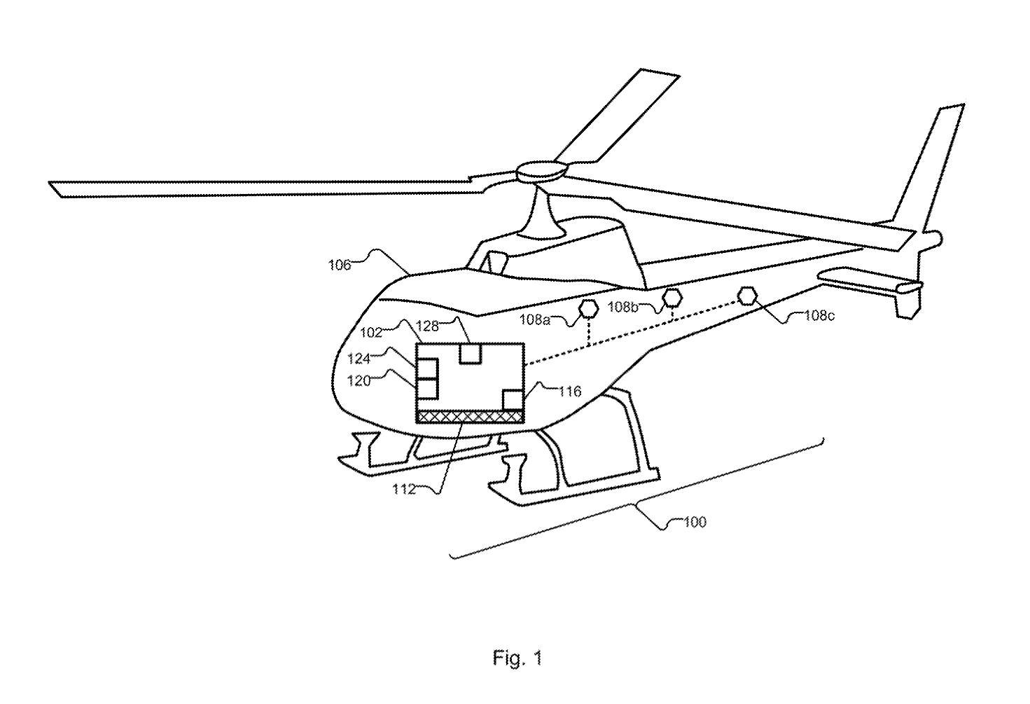

In order to monitor, record, and download aircraft operation data, as well as assess parameters needed for regime recognition, a flight operations monitoring and recording system (FOMRS) is included on an aircraft. Turning to FIG. 1, components of a FOMRS 100 typically would include a HUMS unit 102 on an aircraft such as a helicopter 106. HUMS unit 102 will be equipped with and/or connected to a variety of instruments or sensors 108 (e.g., 108a-c) and parameter feeds. It is advisable for HUMS unit 102 to be designed with a suspension system 112 to reduce the impact acceleration (also known as G load) so as to improve survivability. HUMS 102 would preferably also incorporate a power storage device 116, such as a battery or ultracapacitor, an inertial measurement unit 120, and a GPS 124. Power storage device 116, in the event of loss of power due to a mishap, can power HUMS unit 102, inertial measurement unit 120, GPS 124, and a cellular modern 128. Inertial measurement unit 120 and GPS 124 allow HUMS unit 102 to determine information about the state of an aircraft if aircraft avionics are unavailable. Thus, in the event of lost power or a mishap. HUMS unit 102 is not dependent on the aircraft for information. In addition, cellular modem 128 can transmit data in the event of an aircraft power loss.

Including cellular modem 128 and power storage device 116 in HUMS unit 102 does not greatly affect cost or weight. Because the need to use cellular modem 128 to transfer data is relatively rare (usually only in cases of hard landings or mishaps), the cost of a data plan needed to be able to transfer aircraft operation data should be low. Further, including inertial measurement unit 120 and GPS 124 in HUMS unit 102 reduces the number of aircraft interfaces required between aircraft instruments or sensors and HUMS unit 102 since much of the needed aircraft operation data can be acquired from inertial measurement unit 120 and GPS 124. Reducing aircraft interfaces likewise reduces the cost and weight associated with installing HUMS unit 102 in an aircraft.

As discussed in more detail below, because the aircraft operation data is transferred within seconds after the determination of a possible mishap or hard landing, the aircraft operation data will be preserved away from the aircraft even if a mishap causes damage to persistent memory in HUMS unit 102. A quick download of aircraft operation data also protects information that may be needed for any investigation related to the aircraft operation. In addition, the downloaded aircraft operation data would include positional information that could be used to help locate an aircraft.

Most Part 27 aircraft fly over land and so in many cases will be within cellular connectivity. For those operations, however, in which aircraft do operate in remote locations or over water, a HUMS can be equipped with a satellite modem for data transfer in the event of a mishap that occurs outside of cellular connectivity. Because the use of satellite data will be relatively rare, the cost of the data plan will be low. As noted, the use of satellite modem or cellular modem only occurs when an operation is terminated due to a mishap, hard landing or other event that may be of interest.

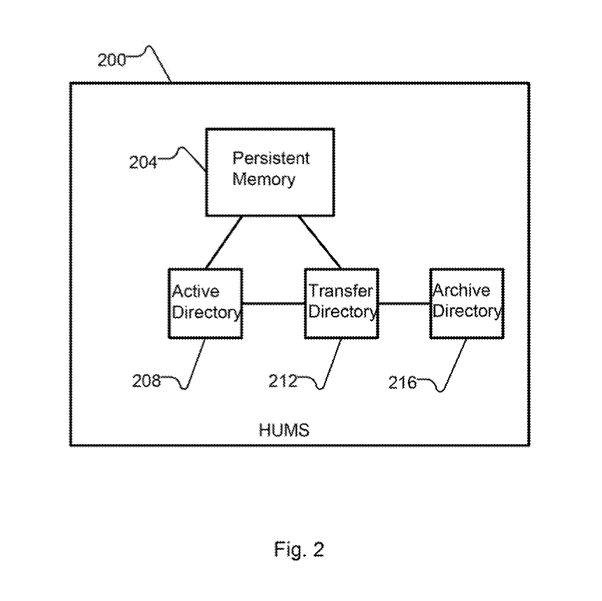

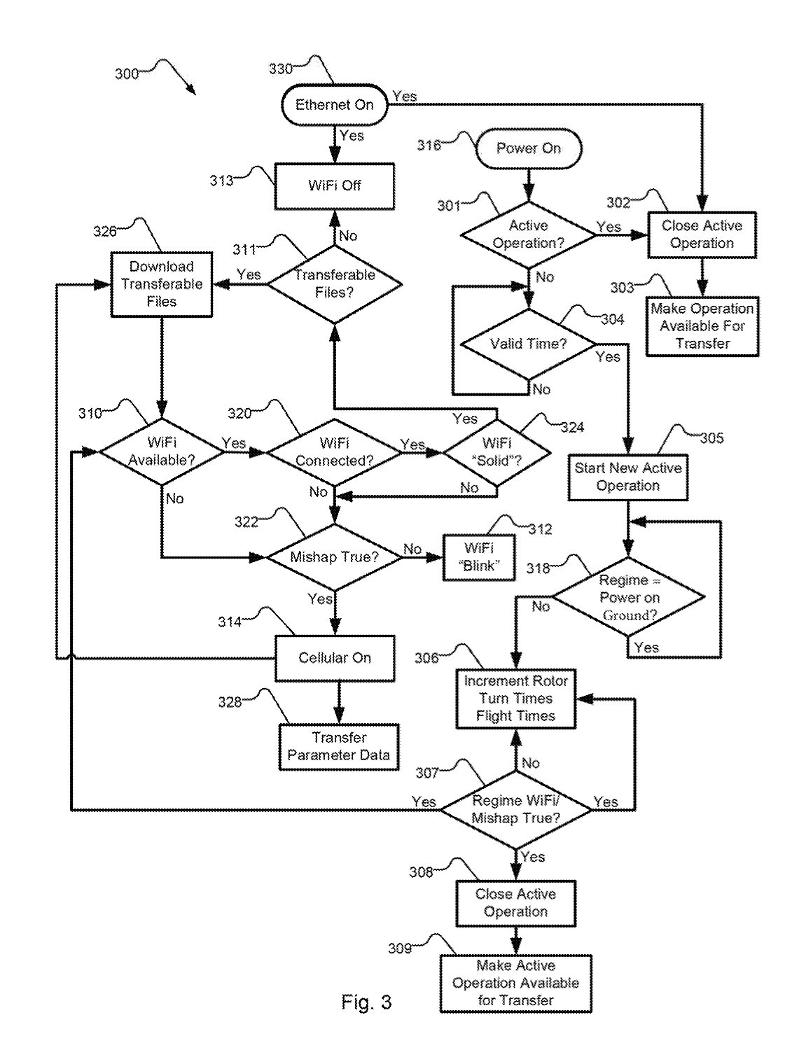

Turning to a discussion of FIGS. 2 and 3, there is shown another exemplary embodiment of a HUMS unit, HUMS unit 200, and an exemplary aircraft operation data recording and downloading process 300. HUMS unit 200 includes a persistent memory 204, an active directory 208 a transfer directory 212 and an archive directory 216. Files created for and associated with an aircraft operation for aircraft operation data are stored within persistent memory 204. The files can be located in different directories depending on the status of the files. Active directory 208 holds files that are created for new aircraft operations and containing aircraft operation data being recorded during an ongoing aircraft operation. Transfer directory 212 holds files that contain aircraft operation data related to completed operations or parts of operations and are available for download. Archive directory 216 holds files with aircraft operation data that have been downloaded from the aircraft. Periodically, HUMS 200 will delete archived files if the storage becomes insufficient.

When, for example, an aircraft is first powered up (at step 316), aircraft operation data recording, and downloading process 300 may begin by determining if there are any files in active directory 208 at step 301 of FIG. 3. If there are any files in active directory 208 upon power up, the aircraft operation associated with those files is deemed closed in step 302 and those files are moved to transfer directory 212 in step 303.

When the files have been removed from active directory 208 or there are no files in active directory 208 on power up, a new operation file will be opened (step 305) if there is a valid time detected by HUMS unit 200. A new aircraft operation file is only created if there is a valid time determined from the GPS at step 304. From a cold start, the GPS will get data within 30 seconds of power up. Since a pilot will not fly without a functioning GPS/navigation system, it is unlikely that a pilot would commence rotor turn prior to a valid GPS which requires receiving a valid time as well. On a “hot start” (e.g., the restart of the box in flight), a valid time should be available in one second. In the event that a pilot begins an operation without a valid time, a new file for recording aircraft operation data for the newly started aircraft operation will begin accumulating data as soon as a valid time is registered. Newly created aircraft operation files are contained in active directory 208. It should be noted that there is no operation when the HUMS is under external control, such as an active Ethernet connection, the presence of which is determined at step 330.)

During an aircraft operation, many parameters associated with the aircraft's components, location, and motion are recorded and included in an aircraft operation file. For example, an aircraft operation file may include rotor turn time, which is typically considered to be occurring when the main rotor RPM is greater than 10% of maximum main rotor RPM but the aircraft is not in flight. At step 318, it is determined whether the regime is power on ground. If not, then at step 306, rotor turn times and flight times may be incremented. If it is determined that the main rotor RPM is greater than 10% of maximum main rotor RPM but the aircraft is not in flight, the rotor turn time counter is incremented. Data included in aircraft operation files may also include flight time, which can be associated with torque. Typically, if torque is greater than 30% (depending on the aircraft) of maximum recommended torque, then the aircraft is considered to be in flight time. Therefore, if torque is detected as being greater than 30% of the maximum, the flight time counter will also be incremented at step 306.

At step 307, a state or regime that the aircraft is presently, in is determined (for example, based on techniques discussed in detail below). If the aircraft is determined to be in a regime that indicates the aircraft has likely experienced or is likely about, to experience a hard landing or mishap, aircraft operation files in active directory 208 are closed at step 308 and sent to transfer directory 212 at step 309. In addition, when the regime the aircraft is in indicates that the aircraft has likely experienced or is likely about to experience a hard landing or mishap, a determination is made at step 310 whether Wi-Fi is available for downloading files. If Wi-Fi is available, connected (as determined at step 320), and solid (as determined at step 324), aircraft operation files are downloaded from transfer directory 212 at step 311. If Wi-Fi is unavailable, it is determined again whether the determined regime state indicates likely mishap at step 322, and if true then Wi-Fi blinks at step 312 to try to establish a connection. If a connection is established, the aircraft operation files in transfer directory 212 are downloaded at step 326. Wi-Fi turns off at step 313 when all available aircraft operation files have been downloaded from transfer director 212. If Wi-Fi is unable to establish a connection, and the regime the aircraft is determined to be in continues to indicate that the aircraft has likely experienced or is likely about to experience a hard landing or mishap, a cellular modem is turned on at step 314 and any aircraft operation files are downloaded from transfer directory 212. In a preferred embodiment, highest priority sub-files, such as those containing parameter data most important for flight reconstruction and/or determining the current location of the aircraft, are downloaded first at step 328. Once an aircraft operation file has been downloaded by any method, that aircraft operation file is moved to archive directory 216.

As noted above, in order to determine when it may be necessary to preserve aircraft operation data by transferring and/or downloading applicable files or sub-files, it is useful to determine whether an aircraft has likely experienced or is likely about to experience a mishap or hard landing. Such a determination can be more accurately made if the regimes the aircraft has been in and the regime the aircraft is currently in can be accurately determined.

A regime monitor can be used to determine what regime, or state, an aircraft is in based on aircraft operation data. The improved regime recognition technique of the present invention, which can be used to help determine when aircraft operation data should be preserved via the procedure described above, is based on an approach that, for a given probability of false alarm, maximizes the probability of attaining a correct identification of an aircraft regime. Further, the regime recognition technique described herein is computationally simple to implement and configure, and is scalable in that it can easily be expanded to encompass new or different possible regimes. Also, the regime recognition technique incorporates performance characteristics for known regime class (for example, the Receiver Operating Characteristics), in order to better determine the regime an aircraft is in.

The improved regime recognition technique of the present disclosure uses a maximum likelihood estimator (MLE) to determine a regime an aircraft is likely in by comparing measured aircraft operation parameters at a given time to sets of corresponding notional aircraft operation parameters associated with regimes from a set of possible regimes the aircraft could be in. In other words, the regime the aircraft is most likely in is determined by asking which regime typically has parameters that most closely match the parameters that have been measured for this aircraft at a particular time (and/or across a given period of time).

The measured parameters for an aircraft in operation are compared to a set of parameters associated with a possible regime, and this is repeated for every set of parameters associated with each possible regime included in the regime recognition technique. In other words, a finite set of possible regimes, each with a notional set of parameters, is stored for the purpose of comparison to the set of measured parameters for the aircraft. An algorithm outputs a regime that is the most likely of all possible regimes that have been compared.

To make the comparisons, the MLE takes a current set of measurements and calculates a normalized distance between the measurements and notional parameter values associated with a notional set of regimes. The regime from the set of regimes is returned that has the closest parameter values, based on a statistical analysis and correlation described in detail below, to the set of measured parameters as the most likely regime that the aircraft is in. In this way, the MLE is a multiple dimension hypothesis test in which the measured aircraft parameters are used to test a hypothesis that the aircraft is in a given regime.

Table 1 lists 40 possible regimes, though it will be understood that other regimes, more regimes, or fewer regimes could be used. In addition, the regime recognition technique is easily configurable to change the set of possible regimes and/or add new regimes in light of, for example, use of different types of aircraft, different flying environments, or the availability of more data.

TABLE 1

| | |
|---|---|
| Power On Aircraft, Rotors Not Turning | Regime 1 |
| Power On Aircraft, Rotors Turning Flight Idle | Regime 2 |
| (55%) | |
| Power On Aircraft, Rotors Turning Flight RPM | Regime 3 |
| (100%) | |
| Shutdown (Main Rotor >10%, N2<10%) | Regime 4 |
| Impact/Hard Landing (−2 m/sec 5.0 Gs) | Regime 5 |
| In Ground Effect (IGE) Hover | Regime 6 |
| Out of Ground Effect (OGE) Hover | Regime 7 |
| Left Hover Turn | Regime 8 |
| Right Hover Turn | Regime 9 |
| Level Hight up to 0.3 Velocity-never exceed | Regime 10 |
| (“Vne”) | |
| Level Flight up between 0.3 and 0.4 Vne | Regime 11 |
| Level Flight up Between 0.4 and 0.5 Vne | Regime 12 |
| Level Flight up Between 0.5 and 0.6 Vne | Regime 13 |
| Level Flight up Between 0.6 and 0.7 Vne | Regime 14 |
| Level Flight up Between 0.7 and 0.8 Vne | Regime 15 |
| Level Flight up Between 0.8 and 0.9 Vne | Regime 16 |
| Level Flight up Between 0.9 and 1.0 Vne | Regime 17 |
| Best Rate of Climb | Regime 18 |
| Intermediate Power Climb | Regime 19 |
| Takeoff Power Climb | Regime 20 |
| Left Climbing Turn | Regime 21 |
| Right Climbing Turn | Regime 22 |
| Approach | Regime 23 |
| Aggressive Approach | Regime 24 |
| Autorotation | Regime 25 |
| Partial Power Descent | Regime 26 |
| Dive | Regime 27 |
| Level Left Turn: 30 d AOB (angle of bank) | Regime 28 |
| Level Left Turn: 45 d AOB | Regime 29 |
| Level Right Turn: 30 d AOB | Regime 30 |
| Level Right Turn: 45 d AOB | Regime 31 |
| Descending Left Turn: 30 d AOB | Regime 32 |
| Descending Left Turn: 45 d AOB | Regime 33 |
| Descending Right Turn: 30 d AOB | Regime 34 |
| Descending Right Turn: 45 d AOB | Regime 35 |
| Pullout: 1.0 Gs | Regime 36 |
| Pullout: 2.0 Gs | Regime 37 |
| Pullouts: 3.0 Gs | Regime 38 |
| Pushover: 0.1 Gs | Regime 39 |
| Pushover: 0.4 Gs | Regime 40 |

Because a maximum likelihood estimator is used, as with any statistical technique, erroneous regime determinations are possible, e.g., identifying one regime as the regime the aircraft is in when in fact the aircraft is in another regime. But because of the structure of the algorithm disclosed herein, the determined regime, even if not 100% accurate, would still be quite similar to the actual regime the aircraft is in. This is important because from a damage accrual or usage metric, the values associated with the determined regime and actual regime will be nearly the same. For example, if the aircraft is at 42 degrees angle of back, there is some slight probability the algorithm will choose a regime that has a greater than 45 degrees angle of back. However, the structural loads accrued by the airframe are similar for a 30 degree regime and a 45 degree regime.

Each regime has a set of parameters associated with it, some or all of which may have corresponding parameters that are observed or measured on the aircraft in operation. Parameters that can be included in the regime determination may include, for example, the following:

a) Parameters that can be derived internally from a GPS/inertial navigation system:
Latitude, units=radians
Longitude, units=radians
Altitude, units=m
Ground Speed, units=m/s
Altitude Rate, units=m/s
Heading, units=radians
Pitch, units=radians
Roll, units=radians
Pitch Rate, units=radians per second
Roll Rate, units=radians per second
Yaw Rate, units=radians per second
Acceleration X axis, units=meter per sec per sample rate
Acceleration Y axis, units=meter per sec per sample rate
Acceleration Z axis, units=meter per sec per sample rate
Wander Angle, units=radians
Barometric Pressure, units=mbar
INU Temperature, units=° C.
Normalized Acceleration, units=g
Density Altitude, units=meters

b) Parameters that can be derived externally from continuously monitored instruments or sensors:
N1, units=% RPM
N2, units=% RPM
Main Rotor, units=% RPM
Torque, units=% max
Turbine Output Temp, units=° C.
Indicated Airspeed, units=knots
Trans Oil Temp, units=° C.

In an exemplary embodiment of the present invention, the MLE includes a hypothesis test that includes a Bayes classifier, which minimizes the probability of a misclassification, in order to determine the regime based on measured parameters. A probability that the aircraft is in a possible regime given the parameters measured for the aircraft (at a given time) is calculated for each of the possible regimes. (For the example set of possible regimes given above, there are 40 possible regimes an aircraft could be in and so 40 probabilities would be calculated.) The probability that an aircraft is in a regime given a particular set of measured or observed parameters can be denoted as P(Hᵢ|z), where Hᵢ is a possible regime and i runs from 1 to m, with m being the number of possible regimes, which in the example provided would be 40, and z is the set of measured or observed parameters, which can include any combination of, for example, the parameters listed above. (It is assumed that the cross correlation between parameters in a given regime is small, such that the off diagonal covariance values are near zero.) The selected regime will be the one corresponding to the largest calculated probability of a set of m possible regimes.

A decision rule will include a null hypothesis, i.e., whether an aircraft is in a “null” regime (Hₒ) in which, for example, an aircraft is turning on a deck or some other appropriate default case. If the probability that the aircraft is in H₀ (denoted P(Hₒ|z)) is greater than the probability that the aircraft is in any other regime, then the MLE will conclude that the aircraft is in the null regime. The decision rule will thus choose the null hypothesis if:

P(Hₒ|z)>P(H₁|z), P(H₂|z), . . . P(Hₘ|z) (Equation 1)

Otherwise, a regime will be selected that corresponds with the greatest P(Hᵢ|z) from the set of Hᵢ through Hₘ.

For illustrative purposes, consider a binary case, where m is 1, in which case Equation 1 can be simplified and rearranged to the following rules:

$$\begin{matrix}If \frac{P ( {H}_{1} \vert z )}{P ( {H}_{0} \vert z )} > 1 , then {H}_{1} & ( Equation 2 A ) \\ If \frac{P ( {H}_{1} \vert z )}{P ( {H}_{0} \vert z )} < 1 , then {H}_{0} & ( Equation 2 B )\end{matrix}$$

The conditions of Equations 2A-2B state that if the probability that the aircraft is in regime 1 is greater than the probability that the aircraft is in the null regime, chose regime 1; else, choose the null regime.

Equations 2A-2B provide the maximum a posteriori probability criterion, in which the chosen hypothesis corresponds to the maximum of two posterior probabilities. Using Bayes' rules to write the criterion gives:

$$P ( {H}_{i} \vert z ) = \frac{p ( z \vert {H}_{i} ) P ( {H}_{i} )}{p ( z )} , i = 0 , 1 \qquad ( Equation 3 )$$

where p(z) is the probability of measuring the set of z parameters under any conditions, p(z|Hi) is the probability of measuring the, set of z parameters given that an aircraft is in regime i, and P(Hᵢ) is the probability that the aircraft is in regime i under any circumstances in the observation space. Rewriting Equation 3 as two equations, one for i=0 and one for i=1, and then dividing P(H₁|z) by P(H₂|z) gives:

$$\frac{P ( {H}_{1} \vert z )}{P ( {H}_{0} \vert z )} = \frac{p ( z \vert {H}_{1} ) P ( {H}_{1} )}{p ( z \vert {H}_{0} ) P ( {H}_{0} )} \qquad ( Equation 4 )$$

Reorganizing Equation 4 into the test shown in Equations 2A and 2B allows the test of whether the aircraft is in regime 0 or regime 1 to become:

$$\begin{matrix}If \frac{p ( z \vert {H}_{1} )}{p ( z \vert {H}_{2} )} > \frac{P ( {H}_{0} )}{P ( {H}_{1} )} , then {H}_{1} & ( Equation 5 A ) \\ If \frac{p ( z \vert {H}_{1} )}{p ( z \vert {H}_{2} )} < \frac{P ( {H}_{0} )}{P ( {H}_{1} )} , then {H}_{0} & ( Equation 5 B )\end{matrix}$$

A likelihood ratio, I(z), can then be defined as follows:

I(z)=p(z|H₁)/p(z|H₀) (Equation 6)

If I(z) is assumed to be well behaved and everywhere continuous and differentiable, then, without loss of generality, the natural logarithm of both sides of Equations 5A and 5B can be taken. Since the logarithm is a monotonically increasing function, the inequality holds and Equations 5A and 5B become:

$$\begin{matrix}If ln l ( z ) > \frac{P ( {H}_{0} )}{P ( {H}_{1} )} , then {H}_{1} & ( Equation 7 A ) \\ If ln l ( z ) < \frac{P ( {H}_{0} )}{P ( {H}_{1} )} , then {H}_{0} & ( Equation 7 B )\end{matrix}$$

The probability function P(Hᵢ) is usually an exponential function, such as a Rayleigh function, a Gaussian function etc., so taking the log linearizes the function, thereby simplifying the problem.

Again, for illustrative purposes, consider a regime decision involving a binary hypothesis-testing problem (in which there are only two possible regime states an aircraft might be in, e.g., Regime 0 or Regime 1), for which there are four possible outcomes:
1. Regime recognition outputs H₀, and it is true that the aircraft was in Regime 0;
2. Regime recognition outputs H₁, and it is true that the aircraft was in Regime 1;
3. Regime recognition outputs H₁, but the aircraft was actually in Regime 0; and
4. Regime recognition outputs H₀, but the aircraft was actually in Regime 1.

The third and fourth outcomes would constitute regime recognition errors. The third condition is a type error and the fourth condition is a type II error. One technique that can decrease the likelihood of regime recognition errors for a given probability of error is the application of a Bayes Classifier to the above process.

Under many circumstances, a normal distribution is a valid model of the distribution of data. Besides being attractive from a mathematical sense (e.g., there are well established tools and procedures to address data that exhibits a normal distribution, i.e., Gaussian data), many natural phenomena can be described with a Gaussian probability function. Without loss of generality, a Gaussian model can be assumed for a generalized n dimension decision space that can be used to describe the set of parameters, z, used in the regime recognition algorithms.

In the default hypothesis, in which the test is whether an aircraft is in regime 0 (H₀), the mean of a parameter vector space, m₀, represents the parameter values associated with regime 0. The probability distribution function of the set of measured parameters, parameter vector z, given that an aircraft is in regime 0 (H₀), is defined by the Gaussian distribution (centered on m₀):

H₀: m₀=E[z_{0]} (Equation 8)

p(z|H₀)=1/(2π)^{n/2}|Σ₀|^{-½} exp[−½(z−m₀)^{T}Σ₀⁻¹(z−m₀)] (Equation 9)

where z₀ is composed of the measured parameters for the default regime, E is the expectation function (average), T is the transpose operator, z is the parameter vector, Σ₀ is the covariance of the regime 0 parameters, m₀ is the mean of the parameter vector space, and n is the number of dimensions of the decision space (i.e., the number of parameters used).

An alternative hypothesis to the default hypothesis could be that the aircraft is in Regime 1, or H₁, in which case the mean of a parameter vector space, represents the parameter values associated with regime 1. The probability distribution function of the parameter vector, z₁, given H₁, is defined by the Gaussian distribution (centered on m₁):

H₁: m₁=E[z₁] (Equation 10)

p(z|H₁)=1/(2π)^{n/2}|Σ₀|^{-½} exp[−½(z−m₁)^{T}Σ₁⁻¹(z−m₁)] (Equation 11)

where Σᵢ is the covariance of the regime parameters, T is a transpose operator, n is the number of parameters, z is the set of measured parameters, and m₁ is the set of parameter values associated with regime 1.

The normalized distance squared between the set of measured parameters z and the set of mean values of parameters m associated with any given regime can be obtained as follows:

d²=(z−m)^{T}Σ⁻¹(z−m) (Equation 12)

where d is the normalized distance, T is a transpose operator, z is a measured parameter, and m is a mean value of a parameter associated with a particular regime. In Equation 12, for each possible regime to be tested, the mean value and inverse variance may, in a preferred embodiment, be used for each parameter in the system for a possible regime. The inverse variance is preferable because it allows a multiplication operation to be used instead of a division operation during computations.

Substituting the distance function (Equation 12) intra the log likelihood ratio test (Equations 7A and 7B) gives the following conditionals:

If ½[d₀²−d₁²]+½ ln(|Σ₀|/|Σ₁|)>ln(P₀/P₁), then H₁ (Equation 13A)

If ½[d₀²−d₁²]+½ ln(|Σ₀|/|Σ₁|)<ln(P₀/P₁), then H₀ (Equation 13B)

where:
d₀ is the normalized distance between the set of measured parameters z and the mean values of parameters associated with regime 0;
d₁ is the normalized distance between the set of measured parameters z and the mean values of parameters associated with regime 1;
   |Σ₀| is the determinant of the covariance of the measured parameters and the mean values of parameters associated with regime 0;
   |Σ₁| is the determinant of the covariance of the measured parameters and the mean values of parameters associated with regime 1;
P₀ is the probability that the aircraft is in regime 0 given the measured parameters; and
P₁ is the probability that the aircraft is in regime 0 given the measured parameters.

The conditions provided in Equations 13A and 13B provide that if the normalized distance squared between z and m₀ (plus a threshold offset that represents the log ratio of test case probabilities, although it can be assumed that P₀ is equally likely with P₁, such that the offset is ln(1)=0) is greater than the normalized distance between z and m₁, then accept the alternate hypothesis, namely that the aircraft is more likely in regime 1 (H₁) than regime 0 (H₀).

In the example provided herein, where there are 40 possible aircraft regimes, 39 tests against the null hypothesis would have to be conducted to determine the regime the aircraft is most likely in given an observed set of parameters. If, after completing all 39 tests each test is negative, then the null hypothesis (in the example provided that the aircraft is in Regime 0) cannot be rejected. If there are positive test values, then the alternative hypothesis can be accepted for each regime for which there is a positive value, and the regime associated with the maximum test value is the regime that will be determined to be the regime the aircraft was most likely in given the observed set of parameters.

The regime determination update rate is preferably 8 Hz. Since bandwidth of helicopter maneuvers is less than 4 Hz, this allows for a complete reconstruction of the flight for training or mishap investigation.

It should be noted that the parameters used for regimes are not necessarily the same as those that may be used for flight reconstruction, nor must they be output in the same order as those used in regime recognition. Since each HUMS installation may have a different complement of hardware and hence different associated parameters, a regime parameter map may be required to map the parameter values into the regime mean value and inverse variance values. Additionally, a map of parameters for the regime output may be used, which would allow for flight reconstruction.

Each specific regime may also contain an index that identifies other operation information associated with that regime, including, for example:
1. If rotor turn time is accrued;
2. If flight time (FT) is accrued;
3. If an MD (mechanical diagnostics) acquisition can be performed;
4. If a rotor and track balance acquisition can be performed in that regime;
5. If the Wi-Fi can be on for downloading the operations (indicating that the flight operation had terminated); or
6. If the Wi-Fi or other RF transmission (e.g., 4G, satellite communications) is energized to download aircraft state data in the event of a mishap or hard landing.

The output of the regime recognition function, in addition to identifying the regime the aircraft is in, may include any of the following information: time, regime index, a validity/BIT value to indicate if the processing suffered an error or if a parameter was invalid, the count of the number of parameters, and other parameter values that may be useful for reconstructing the flight.

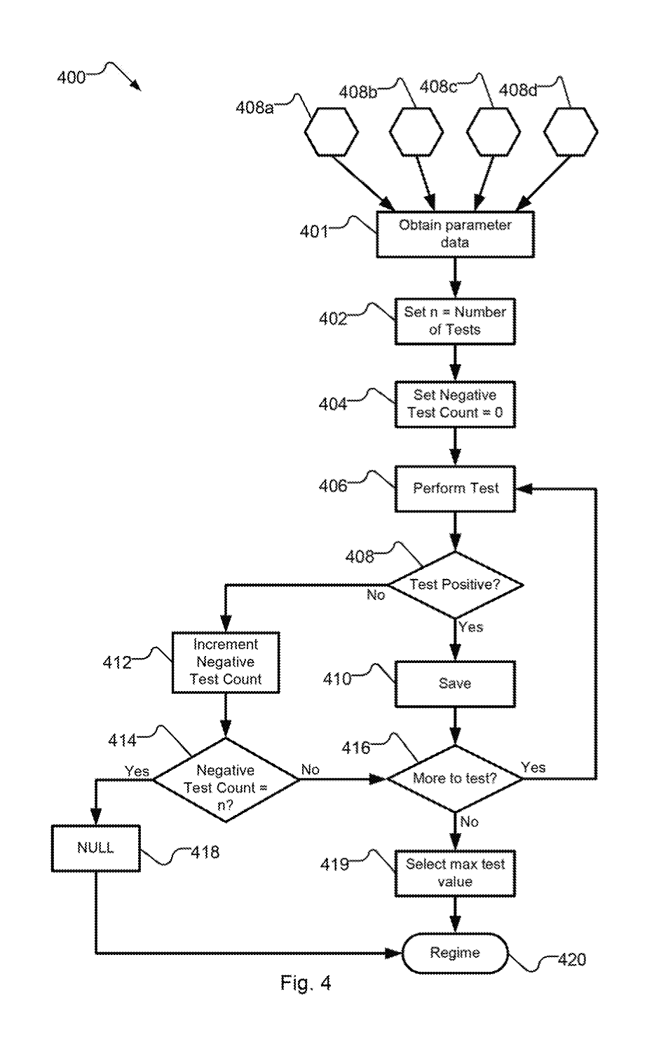

In operation, turning to FIG. 4, another exemplary HUMS unit 400 obtains a set of measured parameters at step 401, preferably at a frequency of 8 Hz, from instruments or sensors (e.g., 408a-408d) or other instruments on the aircraft. The measured parameters are then compared to a set of values for corresponding parameters associated with a test hypothesis regime. Initially, at step 402, the number of tests is set. Then, at step 404, the number of tests that are negative can be set to zero before the set of tests are begun at step 406. If a test is negative, the hypothesis is rejected and the measured parameters are compared to a set of values for corresponding parameters associated with another test hypothesis regime. At step 408, a negative test results in the negative test count being incremented at step 412. If the test is positive, the negative test count is not incremented and the test value for that test is stored at step 410. The process continues if the negative test count does not equal the number of tests and there are more tests to be made, which is determined through step 414 and step 416. The process thus continues until the measured parameters have been tested against the values for all stored possible regimes. When all tests have been completed, the regime the aircraft is most likely in is determined by either not rejecting the null hypothesis (if no positive results are obtained as determined at step 418, which results in the regime associated with the null hypothesis being selected at step 420) or selecting the regime that returned the maximum test value of all the regimes that had positive tests at step 419, which results in the regime associated with the notional parameters that returned the maximum positive value being selected at step 420.

If the determined regime is associated with a hard landing or mishap, flight operation data files may be downloaded off the aircraft via the processes described above.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for preserving flight data comprising:
a plurality of instruments on an aircraft for measuring a set of aircraft operation parameters for the aircraft during operation of the aircraft, wherein each of the parameters has a value;
a regime monitor on the aircraft and in communication with the plurality of instruments, wherein the regime monitor receives the measured set of aircraft operation parameters, determines a normalized distance between the values of the measured set of aircraft operation parameters and a notional set of corresponding parameter values for each of n such sets of corresponding parameter values, each of the n sets being associated with one of n notional regime states, and determines a probability, for each of the n regime states, that the aircraft is in a one of the n regime states based on the determined normalized distances, and wherein the regime monitor selects the one of the n regime states with a highest probability as a current regime state the aircraft is most likely in; and
a HUMS unit on the aircraft, the HUMS unit including a persistent memory, an active directory, a transfer directory, and an archive directory, wherein the HUMS unit contains a file with aircraft operation data recorded during operation of the aircraft and wherein, when the current regime state indicates that the aircraft likely has had or might soon have a mishap, the aircraft operation data is sent to the transfer directory and downloaded from the aircraft.

2. The system of claim 1 further including a GPS and an inertial measurement unit in communication with the HUMS unit.

3. The system of claim 1 further including a power storage device, a cellular modem, and a satellite modem, wherein the power storage device is designed and configured to power the HUMS unit, the cellular modem, and the satellite modem if no other sources of power are available on the aircraft such that the aircraft operation data can be downloaded off the aircraft when no other sources of power are available on the aircraft.

4. The system of claim 1 wherein the regime monitor includes a maximum likelihood estimator for determining the current regime state the aircraft is most likely in.

5. The system of claim 1 wherein the aircraft operation data includes rotor turn time and flight time.

6. The system of claim 1 wherein the set of aircraft operation parameters includes values for latitude, longitude, altitude, ground speed, altitude rate, heading, pitch, roll, yaw rate, acceleration, barometric pressure, RPM of a main rotor, torque, and oil temperature.

7. The system of claim 1 wherein the HUMS unit is supported by a suspension system.

8. The system of claim 1 wherein n is at least 20.

9. The system of claim 1 wherein n is at least 40.

10. A system of preserving flight data comprising:
a HUMS unit on an aircraft, the HUMS unit including a memory and a transfer directory, wherein the memory contains a file with aircraft operation data recorded for the aircraft;
a cellular modem;
a satellite modem;
a power storage device, the power storage device being designed and configured to power the HUMS unit, the cellular modem, and the satellite modem if no other sources of power are available on the aircraft; and
a regime monitor for determining a regime state the aircraft is in, wherein, when the regime state indicates that the aircraft likely has had a mishap or that the aircraft might soon have a mishap, the aircraft operation data is sent to the transfer directory and downloaded from the aircraft via Wi-Fi unless Wi-Fi unavailable, via the cellular modem if the Wi-Fi is unavailable unless cellular connectivity is unavailable, and via the satellite modem if Wi-Fi and cellular connectivity are both unavailable.

11. The system of claim 10 further including a GPS and an inertial measurement unit.

12. The system of claim 10 further including a plurality of instruments on the aircraft for measuring a set of aircraft operation parameters for the aircraft during operation of the aircraft, wherein each of the parameters has a value.

13. The system of claim 12 wherein the regime recognizer receives the set of aircraft operation parameters, determines a normalized distance between the values of the set of aircraft operation parameters and a set of corresponding parameter values for each of n such sets of corresponding parameter values, each set being associated with one of n notional regime states, and determines a probability, for each of the n regime states, that the aircraft is in a one of the n regime states, and wherein the regime monitor selects the one of the n regime states with a highest probability as a current regime state the aircraft is most likely in.

14. The system of claim 13 wherein the aircraft operation parameters include latitude, longitude, altitude, ground speed, altitude rate, heading, pitch, roll, yaw rate, acceleration, barometric pressure, RPM of a main rotor, torque, and oil temperature.

15. The system of claim 13 wherein n is at least 20.

16. The system of claim 13 wherein n is at least 40.

17. The system of claim 10 wherein the HUMS unit is supported by a suspension system.
